(19) United States
(12) Patent Application Publication
(10) Pub. No.: US 2018/0135515 A1
(43) Pub. Date: May 17, 2018

(54) SYSTEM AND METHOD FOR FLUID ACOUSTIC TREATMENT

(71) Applicant: General Electric Company, Schenectady, NY (US)

(72) Inventors: Eric YuHang Fung, Houston, TX (US); Richard Lynn Loud, Ballston Spa, NY (US); Valery Ivanovich Ponyavin, Greenville, SC (US); Dinesh Venugopal Setty, Bangalore (IN); Dariusz Nowak, Birr (CH); Michal Tadeusz Bialkowski, Aargau (PL)

(21) Appl. No.: 15/354,514

(22) Filed: Nov. 17, 2016

(51) Int. Cl. F02C 7/045; F01D 25/30; F01D 25/04

(52) U.S. Cl. CPC F02C 7/045; F01D 25/30; F05D 2230/30; F05D 2220/32; F05D 2230/60; F01D 25/04

(57) ABSTRACT

An acoustic treatment assembly includes a fluid passage and a first panel disposed within the fluid passage. Additionally, at least a portion of a fluid flow through the acoustic treatment assembly is configured to flow across a first micro-perforated surface of the first panel. Further, the first panel includes at least one module, and each module of the at least one module includes the first micro-perforated surface and a respective back surface offset from the first micro-perforated surface opposite the fluid flow across the first micro-perforated surface. The first micro-perforated surface and the back surface form a first cavity configured to promote resonance within a first frequency range of the fluid flow.

### BACKGROUND OF THE INVENTION

The subject matter disclosed herein relates to turbine systems, such as a system and method of arranging panels to attenuate sound associated with the turbine systems.

Turbine systems generally generate loud and disruptive sound during operation. The sound may be emitted from many different parts of the turbine system, from the air intake to the exhaust diffuser. It is desirable to attenuate, or reduce, the sound produced in these turbine systems, but solutions can be heavy, expensive, large, or cause a significant pressure drop in the system. Different turbine systems produce different acoustic profiles, but existing solutions may not be easily modified or customized to these differences.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, an acoustic treatment assembly includes a fluid passage and a first panel disposed within the fluid passage. Additionally, at least a portion of a fluid flow through the acoustic treatment assembly is configured to flow across a first micro-perforated surface of the first panel. Further, the first panel includes at least one module, and each module of the at least one module includes the first micro-perforated surface and a respective back surface offset from the first micro-perforated surface opposite the fluid flow across the first micro-perforated surface. The first micro-perforated surface and the back surface form a first cavity configured to promote resonance within a first frequency range of the fluid flow.

In a second embodiment, an acoustic panel includes a first module including a first micro-perforated surface and a first back surface. The first micro-perforated surface is offset a first distance from the first back surface, a first cavity is formed between the first micro-perforated surface and the first back surface, and the first cavity is configured to promote resonance within a first frequency range of a fluid flow. Additionally, a second module includes a second micro-perforated surface and a second back surface, wherein the second micro-perforated surface is offset a second distance from the second back surface, wherein the first distance is different than the second distance, a second cavity is formed between the second micro-perforated surface and the second back surface, and the second cavity is configured to promote resonance within a second frequency range of the fluid flow.

In a third embodiment, a method of manufacturing an acoustic panel includes installing a first module within the acoustic panel. The first module includes a first micro-perforated surface and a first back surface offset a first distance from the first micro-perforated surface to form a first cavity. The method also includes installing a second module within the acoustic panel downstream from the first module relative to an airflow across the acoustic panel. Additionally, the second module includes a second micro-perforated surface coplanar with the first micro-perforated surface and a second back surface offset a second distance from the second micro-perforated surface to form a second cavity. Further, the first distance is different than the second distance or the first micro-perforated surface is different than the second micro-perforated surface.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine engine system including an air inlet region with an acoustic treatment assembly;

FIG. 2 is a cutaway view of an embodiment of the acoustic treatment assembly of FIG. 1;

FIG. 3 is an exploded view of an embodiment of a module of a panel of the acoustic treatment assembly with a micro-perforated surface;

FIG. 4 is a detail view of the micro-perforated surface of FIG. 3, taken along the line 4-4;

FIG. 5 is a top-down cross-sectional view, taken along line 5-5 of FIG. 2, of an embodiment of a modular micro-perforated panel;

FIG. 6 is a graphical representation of an inlet sound power level profile of a turbine system;

FIG. 7 is a graphical representation of the sound insertion loss associated with one or more panels of the acoustic treatment assembly; and

FIG. 8 is a flow chart of a method of installing micro-perforated panels.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments are directed to turbine systems, and in particular, to systems and methods of arranging modular panels to attenuate sound associated with the flow of fluid inside turbine systems. One or more modular panels may be arranged in an acoustic treatment assembly that may be disposed in a fluid path (e.g. air intake, exhaust outlet). A modular acoustic treatment assembly has several desirable characteristics. In some embodiments, the modular panels are tunable to reduce particular frequency ranges produced by the turbine system. The modular panels may also weigh less than traditional panels with filling (e.g., heavy sound absorption infill material), so that constructing and adjusting the modular panels may reduce costs relative to traditional panels. Additionally, micro-perforations of the modular panels may attenuate sound with a reduced effect on the pressure drop across the panel, relative to a traditional screen panel.

In accordance with present embodiments, an acoustic treatment assembly is configured to reduce the sound from a gas turbine system with modular micro-perforated panels. For simplicity, embodiments of the acoustic treatment assembly described with reference to the figures will be referred to as an acoustic treatment assembly for attenuating or reducing sound in an intake system of a gas turbine system. However, it should be noted that the acoustic treatment assembly may also be configured to attenuate sound in the exhaust system of a gas turbine, or in a different system.

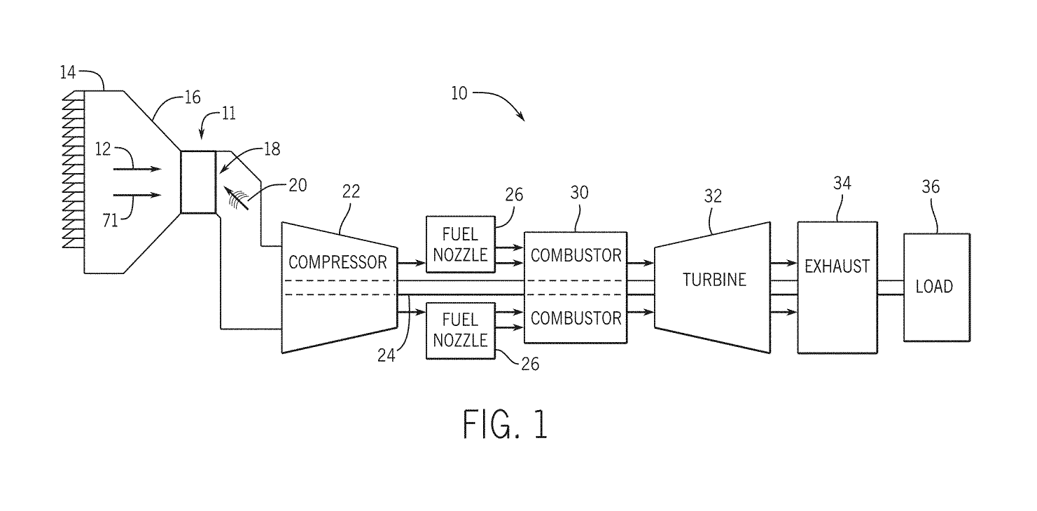

Now turning to the drawings, FIG. 1 is a block diagram of an embodiment of a gas turbine system 10 with an air inlet region 11. The present disclosure may relate to any turbomachine system and the gas turbine system 10 discussed herein does not limit the scope by which the present disclosure applies. A turbomachine system may relate to any system that involves the transfer of energy between a rotor and a fluid, or vice versa, and the illustrated gas turbine engine 10 is only meant to serve as a representation of an embodiment of a turbomachine system.

The gas turbine system 10 includes an air inlet region 11, a compressor 22, one or more turbine combustors 30, and a turbine 32. Air 12 flows from outside of the turbine system 10, into an inlet filter 14 connected to ductwork 16. The gas turbine system 10 draws the air 12 through an acoustic treatment assembly 18 and then draws the air 12 into the compressor 22. The compressor 22 compresses the air 12, thereby increasing the pressure and temperature of the air 12 and directing the air 12 towards the one or more combustors 30.

Each of the one or more turbine combustors 30 may include a fuel nozzle 26, which routes a liquid fuel and/or gas fuel, such as natural gas or syngas, into the respective turbine combustors 30. Each turbine combustor 30 may have multiple fuel nozzles 26. The one or more turbine combustors 30 ignite and combust an air-fuel mixture, and then pass hot pressurized combustion gases (e.g., exhaust) into the turbine 32. Turbine blades are coupled to a shaft 24, which may be coupled to several other components throughout the gas turbine system 10. As the combustion gases pass through the turbine blades in the turbine 32, the turbine 32 is driven into rotation, which causes the shaft 24 to rotate. Eventually, the combustion gases exit the turbine system 10 via an exhaust outlet 34. Further, the shaft 24 may be coupled to a load 36, which is powered via rotation of the shaft 24. For example, the load 36 may be any suitable device that may generate power via the rotational output of the turbine system 10, such as a power generation plant or an external mechanical load. For instance, the load 36 may include an electrical generator, a propeller of an airplane, and so forth. Additionally, or in the alternative, the shaft 24 may drive the compressor 22.

Fluids of the turbine system 10 may produce a loud and disruptive amount of sound 20 that may emanate from any part of the turbine system 10 as the fluids move through the turbine system 10. For example, high fluid speeds through the air inlet region 11 and/or large volumes of fluids through the exhaust outlet may cause sound 20 to emanate from the turbine system 10, unless otherwise mitigated. In the present embodiment, sound 20 in the air inlet region 11 from the compressor 22 is shown in FIG. 1. The acoustic treatment assembly 18 is configured to reduce the sound 20 that travels through the air inlet region of the turbine system 10. As depicted, the acoustic treatment assembly 18 may be disposed along an air path 71 of the air 12 into the turbine system 10. In some embodiments, the acoustic treatment assembly 18 with a micro-perforated surface, as described herein, may reduce or eliminate the pressure drop of the air 12 through the acoustic treatment assembly 18 relative to traditional air intakes, thereby increasing the efficiency of the turbine system 10.

Although the present disclosure refers to air 12 flowing though the turbine system 10, it is to be understood that in the spirit of the present disclosure, any other fluid could be attenuated for sound. The fluid may include, but is not limited to ambient air from the environment, oxygen, oxygen-enriched air, oxygen reduced air, nitrogen, carbon dioxide, or other gases or fluids. The present disclosure also refers to sound 20 from the turbine system 10, but it is also to be understood that in the spirit of the present disclosure, sound 20 could refer to any undesirable acoustic energy emanating from the turbine system 10.

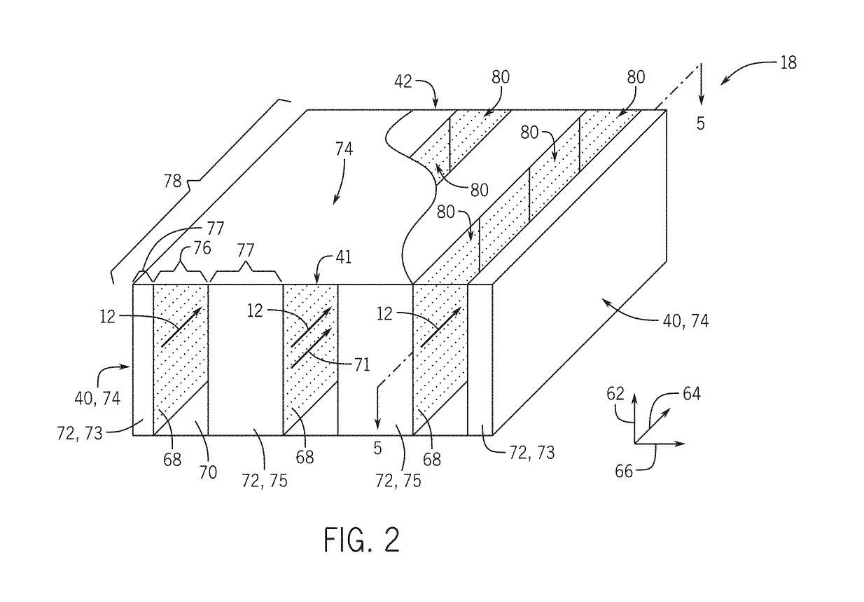

FIG. 2 is a cutaway view of an embodiment of the acoustic treatment assembly 18 of FIG. 1. In the illustrated embodiment, the air 12 moves into the acoustic treatment assembly 18 from an inlet end 41 to an outlet end 42 along the air path 71. In some embodiments, the air path 71 is along a direction similar to a direction 64. Multiple panels 72 form passages 70 of the air path 71 along the length 78 of both the panels 72 and the passages 70. Two panels 72 may face each other on opposite sides of the passages 70. The passages 70 may also have a passage width 76. In some embodiments, the passages 70 are parallel and extend in the direction 64. In certain embodiments, the acoustic treatment assembly 18 may have a cross section that is rectangular, circular, triangular, or any other suitable shape for air 12 to move through.

Multiple panels 72 may be arranged along a direction 66. Though the present embodiment shows four panels 72, there may be a different quantity such as one, two, three, or more panels 72. The panels 72 are surrounded by a casing 74 which encompasses the top and bottom surfaces of all panels 72, as well as the outside faces of panels 72 located at sides 40 of the acoustic treatment assembly 18. The inlets to the passages 70 of the acoustic treatment assembly 18 are in a plane created by directions 62 and 66.

As shown in the present embodiment, the acoustic treatment assembly 18 may contain panels 72 that have different panel widths 77. A double-sided panel 75 may have a panel width 77 that is approximately twice as large as the panel width 77 of a single-sided panel 73. The double-sided panel 75 may be made of two single-sided panels 73 with a shared back surface, or of two single-sided panels 73 with back surfaces that are affixed to each other, so that each side of the double-sided panel 75 has a micro-perforated surface 68. The single-sided panels 73 may be located at either sides 40 of the acoustic treatment assembly 18. Additionally, the single-sided panels 73 may have a smaller width 77 than the double-sided panels 75. Further, the single-sided panels 73 may only have one micro-perforated surface 68 because the other side of the single-sided panel 73 is affixed to or is made of the casing 74. In some embodiments, the panels 72 are parallel and extend the panel length 78 along the direction 64.

Panels 72 may have at least one micro-perforated surface 68. The micro-perforated surfaces 68, described in more detail below, generally have small openings on the order of millimeters (mm) that permit the sound 20 and a small quantity of air 12 to enter an interior of the panel 72. In certain embodiments, the opening may have a diameter of 0.1, 0.5, 1, 3, 5, or 10 mm, or any other diameter suitable for attenuating the sound 20. Moreover, in certain embodiments, the diameter of the opening may be between 1 and 3 mm, between 0.5 and 5 mm, between 0.1 and 10 mm, or any other suitable range for attenuating the sound 20. As discussed herein, in some embodiments, a surface may be classified as micro-perforated if an open area formed by perforations through the surface is less than a certain percentage of the total surface area of the surface. The percentage may be 0.5%, 1%, 5%, 10%, or any other suitable percentage for attenuating the sound 20. In addition, some embodiments the micro-perforated surface has an open area percentage of less than 0.5%, between 0.5% and 10%, between 1% and 5%, or any other suitable range for attenuating the sound 20. In contrast, traditional panels made with screens may have large perforations which form a large open area. Compared to the micro-perforated panels 72, screen panels have a higher surface roughness, thereby creating a larger pressure drop in the air 12.

Further, screen panels are traditionally made with a heavy infill material to reduce sound 20 across the panel 72 through sound absorption. The micro-perforated panels 72 operate on different principles of sound attenuation and may not have a fibrous filling, so the micro-perforated panels 72 are lighter and easier to move than traditional screen panels. In particular, the micro-perforated panels 72 reduce sound 20 by promoting resonance within one or more cavities, as described further below. The configuration (e.g., size, arrangement) of the perforations through the micro-perforated panels 72 and the configuration (e.g., depth, volume, length) of one or more cavities within the micro-perforated panels 72 may promote resonance within the one or more cavities, thereby attenuating the sound 20. In some embodiments, the micro-perforated panels 72 may also have an infill material (e.g., fibrous material, batting) and therefore operate by both absorption and resonance sound attenuation techniques.

Additionally, panels 72 may be constructed of several smaller units known as modules 80, explained in detail below. The modules 80 have micro-perforated surfaces 68 and are arranged along the air path 71 so that air 12 may pass in the direction 64 over multiple modules 80. In some embodiments, the modules 80 have different sound attenuation properties, explained further below, which may configure each module to attenuate sound 20 differently with respect to other modules.

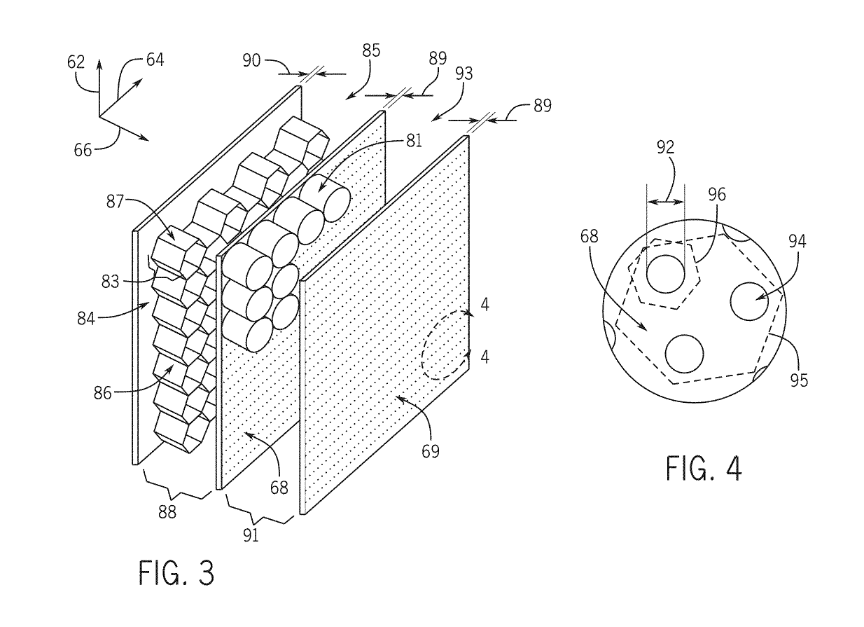

FIG. 3 is an exploded view of an embodiment of a module 80 of the panel 72 with a micro-perforated surface 68. The module 80 also has a back surface 84 and may have one or more structural supports 86 between the micro-perforated surface 68 and the back surface 84. The micro-perforated surface 68 and the back surface 84 are offset from one another in the direction 66 to form a cavity 85. In some embodiments, the one or more structural supports 86 subdivide the cavity 85. An air cavity thickness 88 of the cavity 85 is shown as the interior distance between the micro-perforated surface 68 and the back surface 84. The micro-perforated surface 68 has a micro-perforated plate thickness 89. Similarly, the back surface 84 has a back plate thickness 90. Both the micro-perforated plate thickness 89 and the back plate thickness 90 extend in the direction 66.

The one or more structural supports 86 may be in the shape of hexagonal prisms, triangular prisms, cubes, cylinders, or corrugated baffles, among others. In some embodiments, the multiple structural supports 86 are coupled together to support the micro-perforated surface 68 at respective designated locations. Additionally, or in the alternative, each structural support 86 may be separately placed at a designated location. The one or more structural supports 86 may have a structural support length 83 and may maintain the designated air cavity thickness 88 between the micro-perforated surface 68 and the back surface 84. In some embodiments, repeating three-dimensional units of the structural supports 86 may form a plurality of chambers 87 within the cavity 85 that enable the attenuation of sound 20, such as by absorption or dissipation. These chambers 87 may be arranged in a honeycomb structure (e.g., wherein adjacent rows of structures are offset and/or interlocked) or other structures that effectively minimize compression and/or shear forces between surfaces of the module 80. The other structures by which the chambers 87 may be arranged include, but are not limited to, grids, tessellations, cubic structures, or other suitable structures.

In some embodiments, the module 80 may have a second micro-perforated surface 69. The second micro-perforated surface 69 may be parallel with the micro-perforated surface 68 and offset in the direction 66 from the first micro-perforated surface 68 to form a second cavity 93 with a second air cavity thickness 91. In some embodiments, there may be additional structural supports disposed between the micro-perforated surface 68 and the second micro-perforated surface 69. As shown, structural supports 81 subdivide the second cavity 93. The structural supports 81 are in the shape of cylinders, but may be of any shape or arrangement, as described above. Moreover, in some embodiments, there may be additional micro-perforated surfaces 69 arranged on top of and offset from the micro-perforated surface 68. There may be any quantity (e.g., 2, 3, 4, 5, 6, 7, 8, 9, 10, or more) of micro-perforated surfaces 69 arranged substantially parallel to the micro-perforated surface 68 and offset in the direction 66 from the micro-perforated surface 68, so long as the sound 20 is desirably attenuated. In particular, arranging multiple layers of micro-perforated surfaces 69, with or without structural supports disposed between them, may attenuate the sound 20 in a desirable manner by forming more resonant chambers, as described below with reference to FIG. 4. That is, the resonant chambers in cavities formed by multiple layers of micro-perforated surfaces of a module 80 may enable the module to attenuate the sound 20 for multiple ranges of frequencies.

FIG. 4 illustrates a detail view of the micro-perforated surface 68, taken along line 4-4 of FIG. 3. The micro-perforated surface 68 has micro-perforations 94 that each have a hole diameter 92. In some embodiments, the micro-perforated surface 68 may have micro-perforations 94 of different hole diameters 92. For example, certain rows of micro-perforations 94 may have a first hole diameter 92 and alternating rows of micro-perforations 94 may have a second, larger hole diameter 92. Each of the air cavity thickness 88, the plate thicknesses 89 and 90, and the hole diameter 92 for a module 80 can be customized to achieve different sound attenuation properties, contributing to the sound attenuation of the acoustic treatment assembly 18. Additional properties that can be customized to attenuate sound include the passage width 76, the panel width 77, the panel length 78, the structural support length 83, the structural support 86 shape, the structural support 86 material, the structural support 86 position, the absence of fill material, the micro-perforation 94 shape, the micro-perforation 94 area, and the micro-perforation 94 pattern, which can all be customized to attenuate the sound 20.

Furthermore, the micro-perforated surface 68, the back surface 84, or both surfaces may be formed from corrugated material instead of flat material. Corrugated surfaces attenuate sound 20 differently than flat surfaces, and are thus another type of sound attenuation property that may be customized. When more than one module 80 is inside the same acoustic treatment assembly 18, the use of corrugated surfaces may desirably enhance the attenuation properties of the modules 80.

Each chamber 87 formed by the structural supports 86 may correspond to either one or a multitude of micro-perforations 94 that sound 20 enters. If more than one micro-perforated surface is present, the sound 20 may enter the most outward micro-perforated surface, then enter each micro-perforated surface in turn. Chamber outlines 95 and 96 are representative embodiments of the cross section of the chambers 87 that are coupled to the micro-perforated surface 68. In a first embodiment, the chamber outline 95 corresponds to three micro-perforations 94. In a second embodiment, the chamber outline 96 corresponds to a single micro-perforation 94. Because the chamber outline 96 has a smaller surface area, a greater number of the chambers 87 with chamber outline 96 may be utilized to produce the desired attenuation of the sound 20. Additionally, the attenuation of the sound 20 may correspond to the quantity of micro-perforations 94 that open to each chamber 87.

Modules 80 can be combined together to form a panel 72. The micro-perforated surface 68 of each module 80 may be maintained in the same plane as the micro-perforated surface 68 of all other modules 80 on the same side of the same panel 72, thereby forming a smooth surface for the air 12 to flow past. The modules 80 are disposed adjacent to each other in the same direction (e.g., upstream, downstream) of the flowing air 12 along air path 71. That is, the path from the inlet end 41 to the outlet end 42 may cross several modules 80. Each module 80 may have sound attenuation properties (e.g., the air cavity thickness 88, the plate thicknesses 89 and 90, the hole diameter 92, the passage width 76, the panel width 77, the panel length 78, the structural support length 83, the structural support 86 shape, the structural support 86 material, the structural support 86 position, the absence of fill material, the micro-perforation 94 shape, the micro-perforation 94 area, the micro-perforation 94 pattern, and use of flat or corrugated surfaces) tuned to attenuate a respective set of frequencies. By arranging many modules 80 together to form a panel 72 and optionally also by placing different panels 72 with different sound attenuation properties inside the air intake region 11 of the turbine system 10, a wide spectrum of frequencies of sound 20 (e.g., acoustic profiles) may be attenuated. For example, two or more modules 80 may be arranged within the same panel 72. In another example, two or more modules may be arranged within separate panels 72 inside the same acoustic treatment assembly 18. The modules 80 may then attenuate two or more ranges of wavelengths of the sound 20.

The panel 72 is designed to provide a reduction in acoustical energy (e.g. sound 20). Sound 20 is attenuated when sound waves enter the air cavity thickness 88, or the chambers 87 disposed inside the air cavity thickness 88, through micro-perforations 94. Sound 20 propagating through the micro-perforations 94 creates multiple reflections or resonance of itself. The resonance then interacts with itself and the sound 20 is converted via friction into heat energy that dissipates. At least a portion of the sound 20 is then prevented from exiting the air inlet region 11 because it has been converted into heat energy. Accordingly, the panel 72 promotes (e.g., encourages, creates, amplifies) resonance of certain frequencies of the sound 20 in order to attenuate it.

The first micro-perforated surface 68 and first offset 88 may be configured to attenuate a first frequency range of the sound 20. If a second micro-perforated surface 69 is offset in the direction 66 from the first micro-perforated surface 68, the second micro-perforated surface 69 and second offset 91 may be configured to attenuate a second frequency range of the sound 20. Accordingly, sound from the passage 70 first encounters the second micro-perforated surface 69 to be attenuated. Sound that is not attenuated by the second micro-perforated surface 69 and second offset 91 may travel through the first micro-perforated surface 68 for further attenuation. Therefore, in some embodiments a panel 72 with multiple layers of micro-perforated surfaces may attenuate more frequency ranges or a broader frequency range than a panel 72 with a single micro-perforated surface 68. Micro-perforated surfaces 68, 69 that are offset in the direction 66 from each other may be referred to as being arranged “in series” because the sound 20 may travel through more than one layer of micro-perforated surfaces on its path through the panel section 72. Similarly, micro-perforated surfaces that are disposed adjacent to each other (e.g., coplanar) along the passage 70 may be referred to as being arranged in parallel.

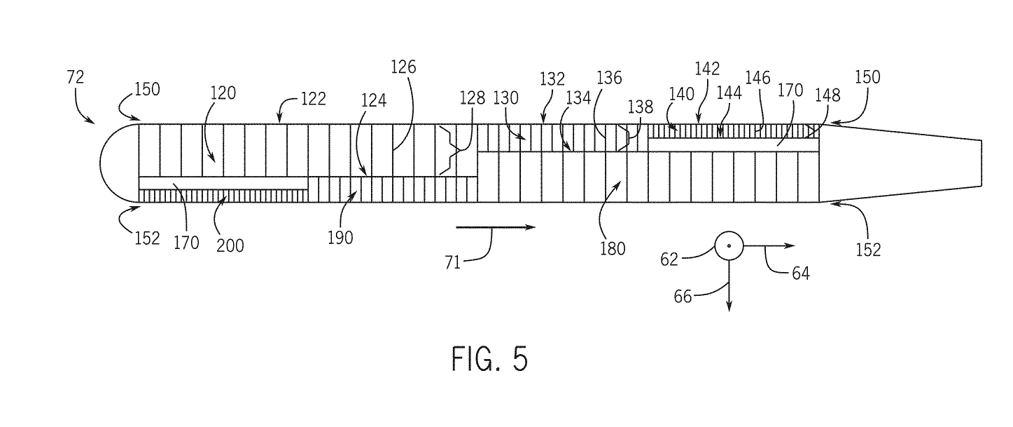

A top-down cross-sectional view of a modular micro-perforated panel 72 (e.g., double-sided panel 75) is shown in FIG. 5. In the current embodiment, the panel 72 contains three modules 80. A first module 120 has a first micro-perforated surface 122, a first back surface 124, a first structural support 126, and a first air cavity thickness 128. Also, a second module 130 has a second micro-perforated surface 132, a second back surface 134, a second structural support 136, and a second air cavity thickness 138. Further, a third module 140 has a third micro-perforated surface 142, a third back surface 144, a third structural support 146, and a third air cavity thickness 148.

In some embodiments, modules 80 of the panel 72 may have one or more of the same sound attenuation properties (e.g., the air cavity thickness 88, the plate thicknesses 89 and 90, the hole diameter 92, the passage width 76, the panel width 77, the panel length 78, the structural support length 83, the structural support 86 shape, the structural support 86 material, the structural support 86 position, the absence of fill material, the micro-perforation 94 shape, the micro-perforation 94 area, the micro-perforation 94 pattern, and use of flat or corrugated surfaces). By way of a non-limiting example, a first module 80 of the panel 72 may have the same micro-perforation hole diameter 92 but a different air cavity thickness 88 than an adjacent second module 80. Additionally, the first module 80 and the second module 80 may both have corrugated micro-perforated surfaces 68, but different micro-perforation 94 shapes. As illustrated, in some embodiments, each module 80 of the panel 72 may have different sound attenuation properties than other modules 80 of the same panel 72, thereby tuning the respective panel 72 to attenuate a different set of frequencies than other modules 80.

In general, the modules 80 of each panel 72 are aligned so that the micro-perforated surfaces 122, 132, and 142 are arranged in the same plane to create a first panel outer wall 150. The air 12 then flows along the panel outer wall 150 along the air path 71. The modules 120, 130, and 140 attenuate the sound 20 carried by the air 12, thereby reducing the decibels (dB) of tuned sets of frequencies corresponding to the sound attenuation properties of each module 120, 130, and 140.

The modules 120, 130, and 140 may be arranged in the panel 72 in series between the inlet end 41 and the outlet end 42 of the acoustic treatment assembly 18. In one embodiment, the first module 120 may be closest to the inlet end 41, the third module 140 may be closest to the outlet end 42, and the second module 130 may be arranged between the modules 120 and 140. The order of the modules 120, 130, and 140 may be changed so that the third module 140 is between the first module 120 and the second module 130, or in any other similar rearrangement. To create a second panel outer wall 152, a fourth module 180, a fifth module 190, and a sixth module 200 are arranged such that their respective micro-perforated surfaces are in the same plane. The order of the modules 180, 190, and 200 can also be rearranged in any manner, provided that their respective micro-perforated surfaces remain in the same plane along the second panel outer wall 152. In some embodiments, the modules 180, 190 and 200 may have sound attenuation properties that correspond to the sound attenuation properties of modules 120, 130, and 140. In other embodiments, the modules 180, 190, and 200 may have one or more sound attenuation properties that do not correspond to a sound attenuation property of modules 120, 130, and 140.

The thickness and depth of each module may also affect the placement of modules 80 when arranging the modules 80 into a panel 72. For example, if the first module 120 has a larger micro-perforated plate thickness 89 than the second module 130, the modules 120, 130 may be arranged so that the external faces of their micro-perforated surfaces 122, 132 are in the same plane. Additionally, if the air cavity thickness 128 of the first module is larger than the air cavity thickness 138 of the second module, the external faces of the micro-perforated surfaces 122 and 132 may still be arranged in the same plane. Furthermore, as discussed above with FIG. 3, some modules 80 may have multiple layers of the micro-perforated surface offset in the direction 66.

The structural supports 126, 136, and 146 of each module 120, 130, and 140 may define the respective air cavity thicknesses 128, 138, and 148. In the present embodiment, the third air cavity thickness 148 is smaller than the other air cavity thicknesses 128 and 138. The first air cavity thickness 128 is the largest and the second air cavity thickness 138 is intermediate in size. A modular panel 72 may be formed by piecing together the modules 120, 130, and 140 with different air cavity thicknesses 128, 138, and 148. Two or more modules 80 may share back surfaces 84, or may each have respective back surfaces 84 that are coupled together, or may be placed inside a panel 72 such that a void 170 is created between the two modules 80. As illustrated in the current embodiment, the structural support 86 of each module 80 is coupled to internal faces of the micro-perforated surface 68 and the back surface 84. The structural support 86 is therefore disposed in a single layer. For example, the first structural support 126 of the first air cavity thickness 128 is coupled to both the internal face of the first micro-perforated surface 122 and the internal face of the first back surface 124. In other embodiments, the first air cavity thickness 128 is adjusted to accommodate different distances between the first micro-perforated panel 122 and the first back surface 124. In some embodiments, the adjustments are made to the length 83 of the first structural support 126 so that the structural support 126 may be long enough to couple to both internal faces of the first module 120.

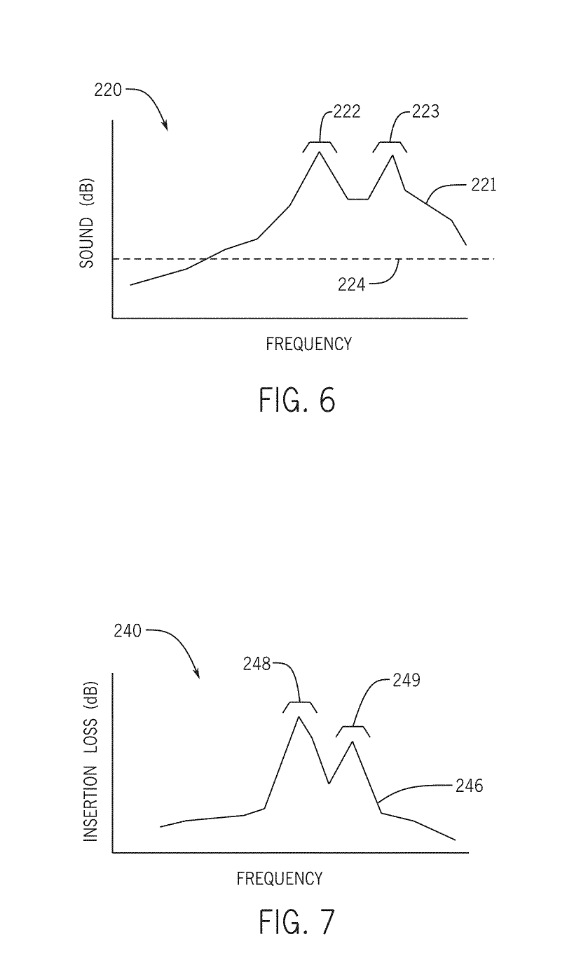

FIG. 6 is a graphical representation 220 of an inlet acoustic profile 221 of a turbine system 10, shown as a function of decibels (dB) versus frequency. The inlet acoustic profile 221 has a first frequency peak 222 and a second frequency peak 223 that each correspond to frequencies of sound 20 that are relatively high in acoustic energy. Advantageous acoustic treatment assemblies 18, as described herein, may attenuate specific frequencies of the sound 20 that correspond to one or more frequency peaks 222, 223 or sets of frequencies. Because each turbine system 10 may have its own unique acoustic profile 221, an acoustic treatment assembly 18 may be assembled which specifically attenuates the frequency peaks 222, 223 that correspond to the loudest frequencies of that particular turbine system 10. Additionally, it may be desirable to reduce the acoustic energy of the entire inlet acoustic profile 221 below a specified dB level or baseline, or it may be desirable to reduce only a portion of the inlet acoustic profile 221 to a lower, specified dB level, similar to a dB target line 224.

For example, FIG. 7 is a graphical representation of the insertion loss 240 in dB as a function of frequency. The insertion loss 240 may be associated with an embodiment having different attenuation properties. As may be appreciated from the discussion with FIGS. 1-5 above, a panel 72 may have different attenuation properties based at least in part on separate modules 80 with different offsets from the back surface 84, a module 80 having multiple layers of micro-perforated surfaces 68, a module 80 having different micro-perforation arrangements, or any combination thereof. Higher values on the y-axis represent a larger reduction in sound 20 for a given frequency. In the present embodiment, the line 246 represents the measured reduction in sound 20 along the passage 70 when a modular micro-perforated panel 72 is installed along the passage 70.

For example, the line 246 may represent the acoustic energy reduction associated with a panel 72 with two modules 80, each having different air cavity thicknesses 88. The panel 72 may be tuned to attenuate the frequencies that correspond to a first set of frequencies 248 and a second set of frequencies 249 of the acoustic energy reduction. Each set of frequencies 248, 249 may be based on the acoustic energy reduction associated with one of the modules 80 of the panel 72. More particularly, a first module 80 may be tuned to attenuate the first set of frequencies 248 and a second module 80 may be tuned to attenuate the second set of frequencies 249.

Measuring the inlet acoustic profile 221 of a turbine system 10 and tuning micro-perforated modules 80 or panels 72 with one or more modules 80 to the frequency peaks 222, 223 may provide effective and targeted reduction in the sound 20. The addition of more modules 80 or different modules 80 may yield an attenuation profile that better approximates a target (e.g., desired, mandated, specified) insertion loss. For example, the panel 72 may be configured so that the first set of frequencies 248 correspond to the first frequency peak 222 of the inlet acoustic profile 221 of FIG. 6, and the second set of frequencies 249 correspond to the second frequency peak 223 of the inlet acoustic profile 221 of FIG. 6. In other words, because it is desirable to reduce the sound 20 of the sets of frequencies that are the loudest, the attenuation properties of the modules 80 or panels 72 may be adjusted so that sets of frequencies (e.g., 248, 249) of insertion loss of FIG. 7 correspond to frequency peaks (e.g., 222, 223) of the inlet acoustic profile 221 of FIG. 6. It is to be understood that the modules 80 may attenuate sets of frequencies 248, 249 that are broader than corresponding peaks 222, 223 of an inlet acoustic profile 221. Additionally, while the current embodiment shows attenuating two frequency peaks 222, 223 with two sets of frequencies 248, 249, it is to be understood that a different quantity of frequency peaks may also be attenuated by a different quantity of sets of frequencies (e.g., one frequency peak attenuated by two sets of frequencies, two frequency peaks attenuated by one set of frequencies, and so on).

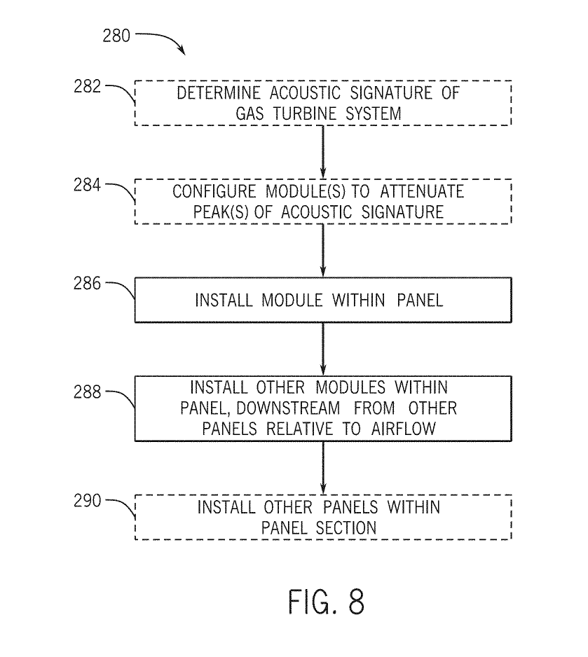

FIG. 8 is a flow chart of an embodiment of a method 280 for installing modular micro-perforated panels 72. The method 280 may include several optional steps. First, the method 280 may optionally include determining (block 282) the acoustic signature 221 of a gas turbine system 10. By sampling relatively high sets of frequencies of sound 20, a graphical representation of an acoustic profile similar to FIG. 6 may be created. Next, modules 80 may be configured (block 284) to specifically attenuate sets of peak frequencies 222, 223, etc. of the acoustic signature 221. The modules 80 may be configured by adjusting their sound attenuation properties, as discussed above.

Further, at least one module 80 is installed (block 286) within the panel 72. Then, other modules 80 are installed (block 288) in the panel 72, downstream of the first module 80 in relation to the air 12 flowing across the panel 72. Optionally, additional panels 72 may be installed (block 290) within the acoustic treatment assembly 18. Each panel 72 may have one or more modules 80 with respective sound attenuation properties to attenuate sets of frequencies of the acoustic signature 221,

Technical effects of the disclosure include an acoustic treatment assembly 18 with one or more panels 72, each having one or more modules 80. The micro-perforated surface 68 of the modules 80 may reduce acoustic energy of the sound 20 from the gas turbine system 10. In some embodiments, sound attenuation properties of each module 80 may be adjusted to attenuate specific sets of frequencies of the sound 20. Because the panels are modular and can be tuned to specific frequencies of the sound 20, the acoustic treatment assembly may be readily adaptable to different turbine systems 10. The presence of micro-perforations 94 in place of traditional perforations also reduces pressure drop across the air inlet section 11.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An acoustic treatment assembly comprising:
a fluid passage; and
a first panel disposed within the fluid passage, wherein at least a portion of a fluid flow through the acoustic treatment assembly is configured to flow across a first micro-perforated surface of the first panel, wherein the first panel comprises at least one module, and each module of the at least one module comprises:
the first micro-perforated surface; and
a respective back surface offset from the first micro-perforated surface opposite the fluid flow across the first micro-perforated surface, wherein the first micro-perforated surface and the back surface form a first cavity configured to promote resonance within a first frequency range of the fluid flow.

2. The acoustic treatment assembly of claim 1, wherein the first panel comprises:
a first module, comprising a first perforation diameter of perforations of the first micro-perforated surface of the first module, a first perforation spacing among the perforations of the first micro-perforated surface of the first module, a first offset distance between the first micro-perforated surface of the first module and a first back surface of the first module, and the first cavity; and
a second module comprising a second perforation diameter of perforations of the first micro-perforated surface of the second module, a second perforation spacing among the perforations of the first micro-perforated surface of the second module, a second offset distance between the first micro-perforated surface of the second module and a second back surface of the second module, and a second cavity configured to promote resonance within a second frequency range of the fluid flow;
wherein at least one of the first perforation diameter is different than the second perforation diameter, the first perforation spacing is different than the second perforation spacing, or the first offset distance is different than the second offset distance.

3. The acoustic treatment assembly of claim 1, wherein the at least one module consists essentially of the first micro-perforated surface, the back surface, and a support structure disposed between the first micro-perforated surface and the respective back surface.

4. The acoustic treatment assembly of claim 1, comprising a second panel disposed within the fluid passage, wherein the second panel comprises a second micro-perforated surface and a second back surface offset from the second micro-perforated surface opposite the fluid flow across the second micro-perforated surface.

5. The acoustic treatment assembly of claim 1, wherein the at least one module comprises a second micro-perforated surface offset from the first micro-perforated surface, wherein the second micro-perforated surface and the first micro-perforated surface are configured to form a second cavity configured to promote resonance within a second frequency range of the fluid flow.

6. The acoustic treatment assembly of claim 1, wherein the first micro-perforated surface comprises a corrugated surface.

7. The acoustic treatment assembly of claim 1, wherein the first panel comprises a support structure disposed between the first micro-perforated surface and the respective back surface.

8. The acoustic treatment assembly of claim 1, wherein the fluid passage is coupled to an intake of a gas turbine system or an exhaust of the gas turbine system.

9. The acoustic treatment assembly of claim 1, wherein the first panel is configured to reduce an acoustic energy of the fluid flow through the acoustic treatment assembly.

10. An acoustic panel comprising:
a first module comprising a first micro-perforated surface and a first back surface, wherein the first micro-perforated surface is offset a first distance from the first back surface, a first cavity is formed between the first micro-perforated surface and the first back surface, and the first cavity is configured to promote resonance within a first frequency range of a fluid flow; and
a second module comprising a second micro-perforated surface and a second back surface, wherein the second micro-perforated surface is offset a second distance from the second back surface, wherein the first distance is different than the second distance, a second cavity is formed between the second micro-perforated surface and the second back surface, and the second cavity is configured to promote resonance within a second frequency range of the fluid flow.

11. The acoustic panel of claim 10, wherein the first micro-perforated surface comprises a first perforation diameter, the second micro-perforated surface comprises a second perforation diameter, and the first perforation diameter is different than the second perforation diameter.

12. The acoustic panel of claim 10, wherein the first micro-perforated surface comprises a first perforation spacing among the perforations of the first micro-perforated surface, the second micro-perforated surface comprises a second perforation spacing among the perforations of the second micro-perforated surface, and the first perforation spacing is different than the second perforation spacing.

13. The acoustic panel of claim 10, wherein an open area of each of the first micro-perforated surface and the second micro-perforated surface is less than 10 percent of respective areas of the first micro-perforated surface and the second micro-perforated surface.

14. The acoustic panel of claim 10, wherein the first module is disposed upstream of the second module relative to a fluid flow across the first micro-perforated surface and the second micro-perforated surface.

15. The acoustic panel of claim 14, wherein the acoustic panel comprises:
a third module comprising a third micro-perforated surface and a third back surface, wherein the third micro-perforated surface is offset a third distance from the third back surface, and the third back surface faces the first back surface of the first module; and
a fourth module comprising a fourth micro-perforated surface and a fourth back surface, wherein the fourth micro-perforated surface is offset a fourth distance from the fourth back surface, the fourth back surface faces the second back surface of the second module, and the third distance is different than the fourth distance.

16. The acoustic panel of claim 15, wherein the third distance is the first distance, and the fourth distance is the second distance.

17. A method of manufacturing an acoustic panel comprising:
installing a first module within the acoustic panel, wherein the first module comprises a first micro-perforated surface and a first back surface offset a first distance from the first micro-perforated surface to form a first cavity; and
installing a second module within the acoustic panel downstream from the first module relative to an airflow across the acoustic panel, wherein the second module comprises a second micro-perforated surface coplanar with the first micro-perforated surface and a second back surface offset a second distance from the second micro-perforated surface to form a second cavity,
wherein the first distance is different than the second distance or the first micro-perforated surface is different than the second micro-perforated surface.

18. The method of claim 17, comprising:
determining an acoustic signature of a fluid flow across the acoustic panel during operation of a gas turbine system;
selecting at least one of the first micro-perforated surface and the first distance based at least in part on the acoustic signature of the fluid flow, wherein the first module is configured to attenuate the acoustic signature of the fluid flow for a first frequency range of the acoustic signature via resonance within the first cavity; and
selecting at least one of the second micro-perforated surface and the second distance based at least in part on the acoustic signature of the fluid flow, wherein the second module is configured to attenuate the acoustic signature of the fluid flow for a second frequency range of the acoustic signature via resonance within the second cavity, wherein the second frequency range is different than the first frequency range.

19. The method of claim 17, comprising installing the first module and the second module without a fill material disposed between the first micro-perforated surface and the first back surface or between the second micro-perforated surface and the second back surface.

20. The method of claim 17, wherein at least one of the first micro-perforated surface and the second micro-perforated surface comprises a corrugated micro-perforated surface.
